(19) United States
(12) Patent Application Publication
(10) Pub. No.: US 2004/0075045 A1
(43) Pub. Date: Apr. 22, 2004

(54) Display

(76) Inventor: Markus Hermsen, Germering (DE)

Correspondence Address: BELL, BOYD & LLOYD, LLC, P. O. BOX 1135, CHICAGO, IL, 60690-1135, US

(21) Appl. No.: 10/467,989

(22) PCT Filed: Jan. 29, 2002
(86) PCT No.: PCT/DE02/00311

(30) Foreign Application Priority Data
Feb. 13, 2001 (DE) 101 06 587.6

(51) Int. Cl. G01J 1/32

(52) U.S. Cl. 250/205; 250/214 B

(57) ABSTRACT

A display apparatus and methods including a display illuminating device and a device for controlling the display illuminating device according to the light intensity of luminous radiation occurring on the display. The light intensity is determined through the use of a light-sensitive element. The light-sensitive measuring element is directly integrated into the display, such as integrated into a COG display controller or COG display driver stage.

### BACKGROUND

The present invention relates to a display, and more particularly a display including a display illuminating device and means to control the display illuminating device according to the light intensity of luminous radiation occurring on the display are determined through the use of a light-sensitive element. The present invention further relates to a device with a display of this type and a method for operating a corresponding display.

Most displays employed today, such as displays in mobile radio devices, pagers, organizers, and other terminals, have a display illuminating device. In the case of self-illuminating types of displays, such as LED (Light Emitting Diode), OLED (Organic Light Emitting Diode), or CRT (Cathode Ray Tube) displays, for example, a display illuminating device is provided whereby the display elements or the display area itself actively emit light (self-illuminating displays). LCDs (Liquid Crystal Displays) in many cases, include reflective LCDs, equipped with an additional source of illumination so they can also be used in dark surroundings, or employ an illuminating device so that the actual display elements can be read at all (transmissive LCDs). Displays of the self-illuminating type require a means for active brightness control. Otherwise, these displays would have to be operated at maximum brightness at all times in order to remain legible even in very bright surroundings (e.g., in direct sunlight). On relatively dark surroundings, however, the display would then appear far too bright for comfortable reading. Active control of the additional light source according to the ambient light offers advantages for displays of the reflective, transmissive, or transreflective type also. Without a control of this type the additional illumination would also have to be activated in very bright surroundings. If, on the other hand, control is effected according to the light intensity of the luminous radiation occurring on the display, it is in many cases possible to save on the energy for illumination when the ambient illumination is sufficient for comfortable reading of the display. When the display is used in a device operated by means of rechargeable batteries, this energy savings is linked directly to an extension of the standby times of the respective device. This is consequently advantageous especially when the display is used in mobile devices.

From practical applications it is already known how to control self-illuminating displays by means of ambient brightness control using a discrete photosensor that is located somewhere inside the case of the device and is not connected directly to the display. The ambient light reaches the photosensor through a small aperture in the case. This has the disadvantage, on the one hand, that the light intensity value being applied to the display is not measured directly. On the other hand, the aperture in the case is relatively small so as not to affect the design of the case. A high degree of sensitivity to dirt or soiling is typical, however, of those devices, where even slight soiling may obscure the aperture and, hence, affect the functioning of the display illumination control.

### SUMMARY

According to a disclosed example, a display is provided including a display illuminating device and a control device configured to control the display illuminating device according to light intensity of luminous radiation occurring on the display. Additionally, a light-sensitive measuring element is used to determine the light intensity and is integrated into the display.

According to another example, a method is provided for operating a display with a display illuminating device. The method includes determining a light intensity of luminous radiation occurring on the display and controlling the display illuminating device according to the determined light intensity wherein the light intensity is determined using a light-sensitive measuring element that is integrated into the display.

### BRIEF DESCRIPTION OF THE DRAWINGS

FIG. 1 illustrates a schematic top view of an LCD display with one COG row driver and one COG column driver.

FIG. 2 illustrates a schematic cross-section of the display according to FIG. 1 along the line of intersection A-A′.

### DETAILED DESCRIPTION OF THE PRESENT EXAMPLES

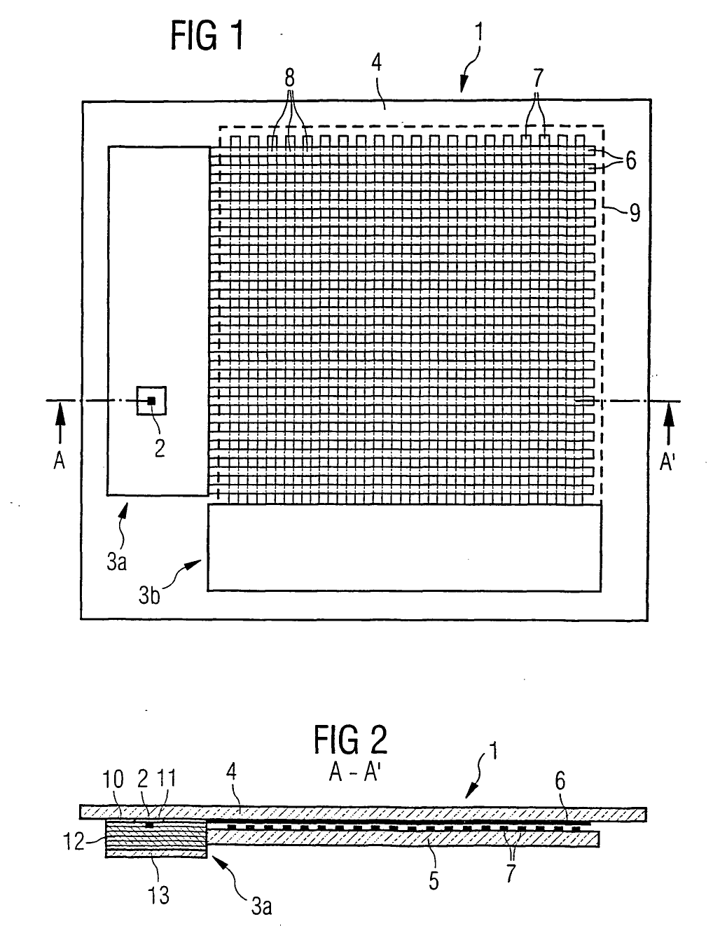

Display 1, shown in rough schematic form in FIGS. 1 and 2, is a LCD 1. This LCD 1 has a first (i.e., from a user's perspective) top display glass 4 and a second display glass 5 below this.

Respectively attached to glasses 4 and 5 on the sides facing each other are strips 6 and 7 made of conducting material, such as translucent ITO (indium-titanium-oxide), for example. The strips include in each case, several strips 6, 7 attached side-by-side in parallel to the glasses 4, 5. The orientation on the two display glasses 4, 5 is selected such that strips 6, 7 of the two display glasses 4, 5 are mutually vertical and so form rows and columns of a matrix. So-called “cells” 8 of the LCD 1 are formed at the intersections 8 at which the LCD row strips 6 and LCD column strips 7 overlap. An LCD liquid is located between the two display glasses 4, 5 with the strips 6, 7 located on them. Applying suitable voltages to the LCD row strips 6 and LCD column strips 7 causes a defined potential difference to arise at a specific cell 8 or cell area between the top display glass 4 and bottom display glass 5 as a result of which the liquid crystals within this cell 8 are put into a specific orientation so that the optical proportions of liquid in this area are changed. The individual cells 8 can in this way be put into a transmitting state in which they are translucent for suitably polarized light, or into a blocking state in which they are opaque and absorb light that is incident from above. In the example of a transreflective display described here, part of the incident light is reflected at the positions of the translucent cells on a back reflector (not shown). Consequently some of the cells 8 appear bright and other cells 8 appear dark, as a result of which the information is shown on the display 1.

For the purpose of driving the LCD a row driver stage 3a and column driver stage 3b are respectively connected to the row strips 6 and the LCD column strips 7. These driver stages 3a, 3b are located directly on the display glass 4, 5 in the form of chrome-on-glass (COG) components. For greater clarity, these driver stages 3a, 3b are shown disproportionately large in the figures in relation to the overall display. They are usually located outside the area 9 visible for the user which is indicated in FIG. 1 by a dashed border. This means they are obscured by the case of the device which contains the display 1.

The layer structure of the COG row driver 3a from FIG. 1 is shown in rough schematic form in FIG. 2. As the lowest layer, this COG row driver 3a has a substrate layer 13 on which are structured the semiconductor layers 12 forming the actual chip.

The row strips 6 on the underside of the top display glass 4 are routed to terminals within these semiconductor layers 12. As the individual semiconductors within these layers 12 are light-sensitive and because faults may be caused by incident luminous radiation, a metalized light-protection layer 10 is located as the top layer of the chip between the display glass 4 and these chip-forming layers 12. This metalized light-protection layer 10 prevents ambient light entering through the display glass 4 from reaching the layers 12.

The row driver 3a can be a conventional, commercially available COG row driver. As its detailed structure is of little significance for the principle of the invention per se, for the sake of clarity and brevity the driver 1 not be further described here. It is significant, however, that a light-sensitive element 2 is used within the chip to measure the light intensity on the display 1. In the example shown, this light-sensitive element 2 is located directly on the surface of the layers 12 directed toward the display glass 4. At this location the metalized light-protection layer 10 has a hole 11 so that light falling on the display glass 4 is routed by the display glass 4, as by an optical waveguide, to the light-sensitive element 2 in the COG 3a. The visible area 9 of the display glass 4 thus forms a large reception area for the light-sensitive element 2. Impairment of the functioning of the light-sensitive element 2 through dirt or soiling, as a consequence, is not possible, in contrast to the case known from the prior art where the light-sensitive element 2 is located behind a separate, small aperture inside the case.

The light-sensitive element 2 is connected via two additional leads or a digital interface (an I2C bus, for example) inside the display connector to a mainboard of the device that controls the display background illumination (not shown).

The display background illumination is a customary illumination that is pulse-operated with a frequency of, for example, a few kHz. In order only to measure the ambient light intensity, the signal that serves as a gauge of the measured overall light intensity and that is routed from the sensitive element 2 to the mainboard is first routed through an extreme low pass filter that filters out the HF signal component produced by the background light so that only the direct-current component corresponding to the measured ambient light intensity is forwarded. This filter can already be located inside the COG row driver 3a. However, the filter can, alternatively, also be located anywhere else in the device, such as on the mainboard, for example, or be implemented by software.

An example of a device with a display of this type is a mobile radio device that automatically does not activate the background illumination when the mobile radio device is being operated in sufficiently bright surroundings, such as in sunlight or in standard room light, for example. On account of this there is a complete saving during standard telephone calls conducted in bright surroundings of the energy required for background illumination, thanks to which the device's standby time can be substantially increased.

In a further example (not shown) the display is an OLED display. Small quantities of this type of novel display are already being offered on the market as commercially available products. These are self-illuminating displays that are very bright in standard operation. This brightness can be adjusted to the ambient light with the aid of the teachings of the present disclosure, which also results in a saving of energy because brightness and energy consumption are proportional.

The present disclosed device provides an economical and simple alternative to the prior art, which obviates the cited disadvantages discussed previously.

As described, the disclosed device features a light-sensitive measuring element that is integrated directly into the display. An additional aperture in the case, which could become soiled, is therefore unnecessary.

Moreover, the light intensity is measured directly at the site of the display itself. The light-sensitive element can be integrated into the display easily and economically. It is also possible to integrate several light-sensitive elements into the display and use these to measure the light intensity.

In one example, the light-sensitive measuring element is integrated into a component which is located on a display glass. For the purposes of this disclosure the term ‘display glass’ also refers to a plastic or synthetic glass. The component is preferably an integrated circuit attached to the display glass. Such components are customarily mounted on the display glass by means of COG (Chip On Glass) technology. Modern displays generally already have appropriate COG components, these frequently being a display controller or a display driver stage, for example a column driver or row driver.

The light-sensitive element within a COG component of this type can be any semiconductor element that responds to incident light and changes its properties. It can, for example, be a diode in the reverse direction whose reverse current is proportional to the light incidence and that can accordingly be used as a measure of the light intensity. Another example is a transistor in which use is made of the phototransistor effect. A light-sensitive element of this type or even a light-sensitive array of several elements can be integrated into the COG component located on a display glass at relatively low cost. Furthermore, the sensitive element within the COG component can even be a semiconductor element that is installed in the COG component on a serial basis during production, but is not used within the relevant device for the special controller and exhibits adequate response to incident light. In this case it is only necessary to have suitable terminals, at which the signal can be tapped, on the COG component for this light-sensitive element.

Alongside favorable overall cost, a further feature of integrating the light-sensitive element into a component located on the display glass is that no additional space is used within the device case to accommodate a sensor of this type. This is particularly official in the case of modern mobile terminals in which space is generally extremely limited. For self-illuminating displays there is a further benefit in accommodating the light-sensitive element in the display controller in that the signal can be used directly within the display controller for controlling the illumination intensity of the display.

For design reasons, most semiconductor components installed in a component with an integrated circuit customarily respond sensitively to light, which usually gives rise to faults within the integrated circuit. The component itself or the semiconductor components inside it must consequently be shielded by an opaque protective layer. With an COG component, this protection is generally provided by shielding the COG component, which is attached directly to the display glass, on the other side of the glass by means of a suitable protective varnish or sticker. It is possible to apply a light-protection layer to the surface of the COG component by means of metalizing. This prevents the light that is incident upon the display glass from being routed by the display glass to the components of the COG and giving rise to faults there.

In another example, it is ensured that this opaque protective layer of the COG component has an aperture and that the aperture and light-sensitive measuring element in the component are mutually disposed such that the luminous radiation occurring on the display or display glass reaches the light-sensitive measuring element through the display glass and aperture. During the process of applying the protective varnish by means of a printing process and/or the process of metalizing relevant areas of the COG component, no additional costs will be incurred by excluding the light-sensitive area or light-sensitive element from protective varnishing and/or metalizing. All that is required is a modified mask within the printing process and/or semiconductor process so that the cost of measuring the light intensity is negligible, such as when a semiconductor element is used that is located in a standard component, but not used otherwise.

As discussed above, the light-sensitive element integrated into the display also can be connected, for example, to a main control of the device containing the display solely by adding two further leads to the display connector.

As disclosed previously, a device that converts the light intensity determined by the light measurement into a digit value is integrated directly into the display, preferably into the COG itself. This means that within the display a complete sensor device is constructed in which the output signal is converted into digital information with a resolution of one or more bits. This digital information can be accessed via the display controller and its digital interface. In a further example, the measuring element itself generates a digital value. This is essentially a type of switch that changes over above a threshold light intensity so that only the digital values 1 or 0 are determined.

The disclosed display also may include a measuring device that, by means of the light-sensitive element, only determines the ambient light intensity occurring on the display independently of the light produced by the display illuminating device itself. This measuring device can be designed as a separate device. However, it can also be integrated within the device control or into the display controller or similar components. Depending on the type of measuring device, this device can also be integrated within the existing controls purely through software means.

Measuring the ambient light intensity independently of the light intensity of the display illuminating device has a benefit that the display illuminating device can be controlled as a function of the ambient light intensity. In contrast to a method where control takes place as a function of the overall light intensity such that, for example, the same overall light intensity is always measured on the display, it is possible with the disclosed device to precisely define at what ambient light intensity and to what extent artificial illumination is provided by the display illuminating device. This means that the illumination does not, for example, necessarily have to be provided as a reciprocal function of the ambient light so that there is only strong illumination in the presence of little ambient light, and vice versa.

This is because a particularly intense illumination is provided specifically at the limits, when the ambient light no longer quite suffices to read the display as the user's eye is at that instant still adjusted to more intense brightness. In completely dark surroundings, on the other hand, a relatively weak display illumination will suffice. A further advantage of this control dependent purely on ambient light is apparent particularly in the case of displays that operate in a reflective manner in bright ambient light and that in dark surroundings, are illuminated by what is termed a ‘backlight’, where the display illuminating device illuminates the image from behind. With displays of this type, inversion (contrast inversion) of the image takes place during illumination owing to the transmissive effect of the LCD cells, which means that dark points become bright points and bright points become dark points. If the ambient light and backlight are of equal intensity when this occurs, the effects will consequently exactly cancel each other out and absolutely nothing will be visible on the display. With these displays, the light intensity of the backlight must therefore always be greater than the ambient light intensity when the backlight is used.

In the case of self-illuminating displays the illumination of the display elements or display area must in just the same way be more intense the brighter the surroundings in order to provide sufficient contrast.

Measuring the ambient light intensity independently of the intensity of the artificial display illumination can be implemented simply when the display illuminating device operates only intermittently, meaning when, at specific times, no light is emitted. The measuring device can then, for example, be designed such that the light intensity is determined by means of the sensitive measuring element only when the display illuminating device is not emitting any light. Measurements, for example, will otherwise not be taken into account or read out or the sensitive element will be inactive.

With most displays the display illuminating device is operated in a pulsating manner as this permits simple dimming of the light. In such cases the measuring device can simply be set to be in synchronism with the clock of the display illuminating device such that the light intensity is always measured precisely when the display illuminating device is off.

As was disclosed previously, a further example for implementing the measuring device in the case of a display illuminating device operated in a pulsating manner includes employing a measuring device that has a filtering device that filters out that portion of the determined light intensity value produced by the display illuminating device. It is sufficient to use, for example, a low pass filter for the filtering device as the ambient light essentially produces a direct-current signal on the measuring element and the artificial light from the pulsating display illuminating device is superimposed on this signal as a HF signal.

Although preferred examples have been disclosed for illustrative purposes, those of ordinary skill in the art will appreciate that the scope of this patent is not limited thereto. On the contrary, this patent covers all apparatus and methods found within the scope of the appended claims.

1. Display (1) with a display illuminating device and means for controlling the display illuminating device according to the light intensity of luminous radiation occurring on said display (1), determined by means of a light-sensitive element (2) characterized in that the light-sensitive measuring element (2) is integrated into the display (1).

2. Display according to claim 1 characterized in that the light-sensitive measuring element (2) is integrated into a component (3a) which is located on a display glass (4).

3. Display according to claim 2 characterized in that the component (3a) includes an integrated circuit attached to the display glass (4).

4. Display according to claim 2 or 3 characterized in that the component (3a) located on the display glass (4) is shielded from incident light by means of an opaque protective layer (10) which has an aperture (11), and in that the aperture (11) and the light-sensitive measuring element (2) in the component (3a) are mutually disposed such that the incident luminous radiation reaches the light-sensitive measuring element (2) through the aperture (11).

5. Display according to one of the claims 2 to 4 characterized in that the component (3a) includes a display controller and/or a display driver stage (3a).

6. Display according to one of the claims 1 to 5 characterized by a measuring device which by means of the light-sensitive measuring element determines an ambient light intensity incident on the display.

7. Display according to claim 6 characterized in that the display illuminating device operates in a pulsating manner and in that the measuring device has a filtering device which filters out that portion of the light intensity, determined by means of the light-sensitive measuring element, that is produced by the display illuminating device.

8. Display according to claim 6 characterized in that the display illuminating device operates intermittently and in that the measuring device has means for determining the light intensity by means of the sensitive measuring element only when the display illuminating device is not producing any light.

9. Display according to one of the claims 1 to 8 characterized in that the measuring element determines a digital value or in that a device that converts the light intensity determined by means of the measuring element into a digital value is integrated into the display.

10. Device with a display according to one of the claims 1 to 9.

11. Method for operating a display (1) with a display illuminating device wherein a light intensity of a luminous radiation occurring on the display (1) is determined and the display illuminating device is controlled according to the determined light intensity, characterized in that the light intensity is determined by means of a light-sensitive measuring element (2) integrated into the display (1).

12. Method according to claim 11 characterized in that an ambient light intensity occurring on the display is measured.

13. Method according to claim 12 characterized in that the display illuminating device operates in a pulsating manner and in that a portion of the determined light intensity produced by the display illuminating device is filtered out.

14. Method according to claim 12 characterized in that the display illuminating device operates intermittently and in that the light intensity is only determined when the display illuminating device is not producing any light.
